(19) United States
(12) Patent Application Publication
(10) Pub. No.: US 2024/0419562 A1
(43) Pub. Date: Dec. 19, 2024

(54) STORAGE SYSTEM AND CONTROL METHOD FOR STORAGE SYSTEM

(71) Applicant: HITACHI, LTD., Tokyo (JP)

(72) Inventors: Takeru CHIBA, Tokyo (JP); Yoshinori OHIRA, Tokyo (JP); Takahiro YAMAMOTO, Tokyo (JP); Katsuto SATO, Tokyo (JP)

(73) Assignee: HITACHI, LTD., Tokyo (JP)

(21) Appl. No.: 18/598,063

(22) Filed: Mar. 7, 2024

(30) Foreign Application Priority Data
Jun. 15, 2023 (JP) 2023-098629

(51) Int. Cl. G06F 11/16

(52) U.S. Cl. CPC G06F 11/1662; G06F 11/1612

(57) ABSTRACT

The present invention provides a storage system and a storage system control method that have high failure tolerance but are small in construction cost.

The storage system runs on a plurality of cloud computers disposed in a plurality of different zones, and includes storage nodes that are disposed in the plurality of computers in the plurality of zones to process inputted/outputted data. The storage nodes include a first storage node and a second storage node. The first storage node operates during normal operation. The second storage node is present in a zone different from that where the first storage node is present, and is able to take over processing of the first storage node. The plurality of cloud computers have a storage device and a virtual storage device. The storage device physically stores data that is to be processed by the storage nodes. The virtual storage device stores data that is made redundant between the zones by a plurality of the storage devices disposed in the different zones. The storage system accesses data in the virtual storage device by using storage control information, and stores the storage system in the virtual storage device. The virtual storage device makes the stored data redundant between the zones. If a failure occurs in a zone including the first storage node, the second storage node takes over the processing of the first storage node by using the data made redundant between the zones.

### BACKGROUND OF THE INVENTION

### 1. Field of the Invention

The present invention relates to a storage system and a control method for the storage system, and more particularly relates to a storage system having nodes and a control method for the storage system.

### 2. Description of the Related Art

A software-defined storage (SDS) is becoming popular. The SDS is a storage device that is constructed by installing software having a storage function on a general-purpose server device.

The above-described technology makes it possible to close a control information reading process within a server while maintaining reliability, and thus offers an advantage in that it achieves higher performance. Meanwhile, in recent years, clouds (particularly, public clouds) are becoming popular as storage system platforms. In the public clouds, public cloud vendors are providing services that offer computer resources and storage resources as an infrastructure as a service (IaaS).

Users of the public clouds can access computer services and storage services on the public clouds through an application programming interface (API), and obtain the necessary amount of computer resources and storage resources at a required point of time. Further, the users can swiftly change the configuration of such resources.

In addition, in general, as regards the storage services on the public clouds, user data is redundant between a plurality of different physical devices. As a result, high reliability is achieved. In recent years, services that make data redundant between a plurality of data centers are available. This makes it possible to prevent data loss even in the event of a failure in the individual data centers.

A plurality of storage systems are described in JP-2022-122993-A. Processing performed by the plurality of storage systems includes a step that is performed in response to detection of a trigger event by a first storage system to request an intermediation service for providing intermediation, a step that is performed in response to detection of a trigger event by a second storage system to request an intermediation service for providing intermediation, and a step that is performed, in response to a positive intermediation result displayed by the intermediation service, by the first storage system in place of the second storage system to process a data storage request made to data sets that are to be synchronously replicated across the first and second storage systems.

### SUMMARY OF THE INVENTION

In a case where a storage system is constructed by use of only computer resources and storage resources which are present within a specific single data center, the storage system stops and data loss occurs if the entire data center fails due, for instance, to a large-scale disaster. Meanwhile, in a case where the method of creating redundant storage systems across a plurality of data centers is adopted to prevent system stoppage and data loss in the event of a failure in individual data centers, it is necessary to construct a standby system in a different data center. Therefore, there is a problem that the resulting construction cost is higher than in the case where the storage system is constructed in a single data center.

The present invention has been made in view of the above circumstances, and is intended to provide a storage system and a storage system control method that have high failure tolerance but are small in construction cost.

In order to address the above-described problems, according to an aspect of the present invention, there is provided a storage system that runs on a plurality of cloud computers disposed in a plurality of different zones. The storage system includes storage nodes that are disposed in the plurality of computers in the plurality of zones to process inputted/outputted data. The storage nodes include a first storage node and a second storage node. The first storage node operates during normal operation. The second storage node is present in a zone different from that where the first storage node is present, and is able to take over processing of the first storage node. The plurality of cloud computers have a storage device and a virtual storage device. The storage device physically stores data that is to be processed by the storage nodes. The virtual storage device stores data that is made redundant between the zones by a plurality of the storage devices disposed in the different zones. The storage system accesses data in the virtual storage device by using storage control information, and stores the storage system in the virtual storage device. The virtual storage device makes the stored data redundant between the zones. If a failure occurs in a zone including the first storage node, the second storage node takes over the processing of the first storage node by using the data made redundant between the zones. In this case, it is possible to provide a storage system that has high failure tolerance but is small in construction cost.

Here, the virtual storage device makes the stored data and the storage control information redundant between the zones. If a failure occurs in a zone including the first storage node, the second storage node is able to take over the processing of the first storage node by using the data and the storage control information that are made redundant between the zones. In this case, the reliability of a process of causing the second storage node to take over the processing of the first storage node is improved.

During normal operation of the first storage node, the virtual storage device is not connected to a storage node other than the first storage node. If a failure occurs in a zone including the first storage node, the virtual storage device connected to the first storage node in the same zone as that where the first storage node is present is detached therefrom and then attached to the second storage node in the same zone as that where the second storage node is present. In this case, even if a failure occurs in a zone including the first storage node, a service can be continued.

Further, if a failure occurs in a zone including the first storage node, the virtual storage device attached to the second storage node in the same zone as that where the second storage node is present is able to achieve virtual memory by using the storage device that is present in the same zone as that where the second storage node is present. In this case, the actual data is present in the storage device in the same zone as that where the second storage node is present. Therefore, when an input/output (I/O) request is received from the second storage node, cross-zone access does not occur. This makes it possible to prevent performance degradation.

In addition, if a failure occurs only in the first storage node, the virtual storage device attached to the second storage node in the same zone as that where the second storage node is present is able to achieve virtual memory by using a storage device that is present in the same zone as that where the first storage node is present, in addition to the storage device that is present in the same zone as that where the second storage node is present. In this case, it is possible to maintain a redundant configuration of the storage devices.

Moreover, when a third storage node and a second virtual storage device connected to the third storage node are present in the same zone as that where the first storage node is present, the first storage node and the virtual storage device are made redundant within the same zone. In this case, storage nodes and virtual storage devices can be made redundant within the same zone.

Further, if a failure occurs only in the first storage node, the storage system can operate the third storage node and the second virtual storage device that are present in the same zone as that where the first storage node is present. In this case, even if a failure occurs, it can be dealt with within the same zone.

In addition, the virtual storage device can be used as a cloud storage device. This makes it easy to obtain storage resources at a required point of time.

According to another aspect of the present invention, there is provided a control method for a storage system that is implemented by allowing a processor to execute software recorded in a memory and is configured to run on a plurality of cloud computers disposed in a plurality of different zones. The storage system includes storage nodes that are disposed in the plurality of computers in the plurality of zones to process inputted/outputted data. The storage nodes include a first storage node and a second storage node. The first storage node operates during normal operation. The second storage node is present in a zone different from that where the first storage node is present, and is able to take over processing of the first storage node. The plurality of cloud computers have a storage device and a virtual storage device. The storage device physically stores data that is to be processed by the storage nodes. The virtual storage device stores data that is made redundant between the zones by a plurality of the storage devices disposed in the different zones. The storage system accesses data in the virtual storage device by using storage control information, and stores the storage system in the virtual storage device. The virtual storage device makes the stored data redundant between the zones. If a failure occurs in a zone including the first storage node, the second storage node takes over the processing of the first storage node by using the data made redundant between the zones. In this case, it is possible to provide a storage system that has high failure tolerance but is small in construction cost.

According to the present invention, it is possible to provide a storage system and a storage system control method that have high failure tolerance but are small in construction cost.

### BRIEF DESCRIPTION OF THE DRAWINGS

FIG. 1 is a diagram illustrating a configuration of an information processing system according to a first embodiment;

FIG. 2 is a diagram illustrating a hardware configuration of a storage node;

FIG. 3 is a diagram illustrating an example of a configuration of a virtual storage device and a physical storage device and their relation in the first embodiment;

FIG. 4 is a diagram illustrating a memory configuration of a cloud control section in the first embodiment;

FIG. 5 is a diagram illustrating an example of a configuration of a virtual storage device management table in the first embodiment;

FIG. 6 is a diagram illustrating an example of a configuration of a physical storage device management table in the first embodiment;

FIG. 7 is a diagram illustrating an example of a configuration of a virtual storage device mapping table in the first embodiment;

FIG. 8 is a diagram illustrating a control information storage area;

FIG. 9 is a diagram illustrating a control program storage area;

FIG. 10 illustrates an example of a configuration of a storage cluster having zone failure tolerance provided by a conventional technology;

FIG. 11 is an example of the configuration of the storage cluster having zone failure tolerance in the first embodiment;

FIG. 12 is a diagram illustrating the overview of a case where, for example, a failure occurs in zone 1 in the configuration depicted in FIG. 11;

FIG. 13 is a flowchart illustrating a zone failure detection process;

FIG. 14 is a flowchart illustrating a failover process for zone failure in step S3004 of FIG. 13;

FIG. 15 is a flowchart illustrating a zone recovery detection process;

FIG. 16 is a flowchart illustrating a failback process for zone recovery in step S3204 of FIG. 15;

FIG. 17 is a diagram illustrating the overview of a case where, for example, a failure occurs in a storage node in zone 1 in the configuration depicted in FIG. 11;

FIG. 18 is a diagram illustrating a conventional method for providing redundancy even in the zones;

FIG. 19 is a diagram illustrating a configuration of the information processing system according to a second embodiment; and

FIG. 20 is a diagram illustrating the overview of a case where a failure occurs in zone 1 in the configuration depicted in FIG. 19.

### DESCRIPTION OF THE PREFERRED EMBODIMENTS

Embodiments of the present invention will now be described in detail with reference to the accompanying drawings. It should be noted that the embodiments described below are merely examples for implementing the present invention and do not limit the technical scope of the present invention. Further, the same component elements in the individual drawings are denoted by the same reference numerals.

In the following description, various kinds of information are occasionally expressed in data structures such as “tables,” “lists,” and “queues.” However, the various kinds of information may be expressed in data structures other than those above. In order to indicate that there is no dependence on the data structures, for example, an “XX table” and an “XX list” may be referred to as “XX information.” Such expressions as “identification information,” “identifier,” “name,” “ID,” and “number” are used to describe the contents of various kinds of information. However, these expressions are replaceable with each other.

Further, in the following description, when elements of the same type are explained without distinguishing between them, reference signs or common numbers in the reference signs are used, and when the elements of the same type are explained by distinguishing between them, the reference signs of the elements are used, or IDs assigned to the elements are used instead of the reference signs.

Moreover, in the following description, processing performed by executing a program is occasionally explained. However, the program is executed by at least one or more processors (for example, central processing units (CPUs)) to perform a predetermined process by appropriately using, for example, storage resources (e.g., memories) and/or interface devices (e.g., communication ports). Therefore, the main constituent used to perform processing may be a processor. Similarly, the main constituent used to perform processing by executing a program may be a controller, a device, a system, a computer, a node, a storage system, a storage device, a server, a management computer, a client, or a host as far as they include a processor. The main constituent (e.g., a processor) used to perform processing by executing a program may include a hardware circuit that performs part or all of the processing. For example, the main constituent used to perform processing by executing a program may include a hardware circuit that performs encryption and decryption or compression and decompression. The processors operate according to a program and thus operate as a functional section for implementing predetermined functions. Devices and systems including the processors are devices and systems that include such functional sections.

The program may be installed on a device such as a computer from a program source. The program source may be, for example, a program distribution server or a computer-readable storage medium. When the program source is a program distribution server, the program distribution server may include a processor (e.g., a CPU) and a storage resource, and the storage resource may further store a distribution program and a distribution target program. Further, the processor of the program distribution server may distribute the distribution target program to other computers by executing the distribution program. Moreover, in the following description, two or more programs may be implemented as one program, or one program may be implemented as two or more programs.

Firstly, a first embodiment of the present invention will be described below.

### First Embodiment

### Overview of System Configuration

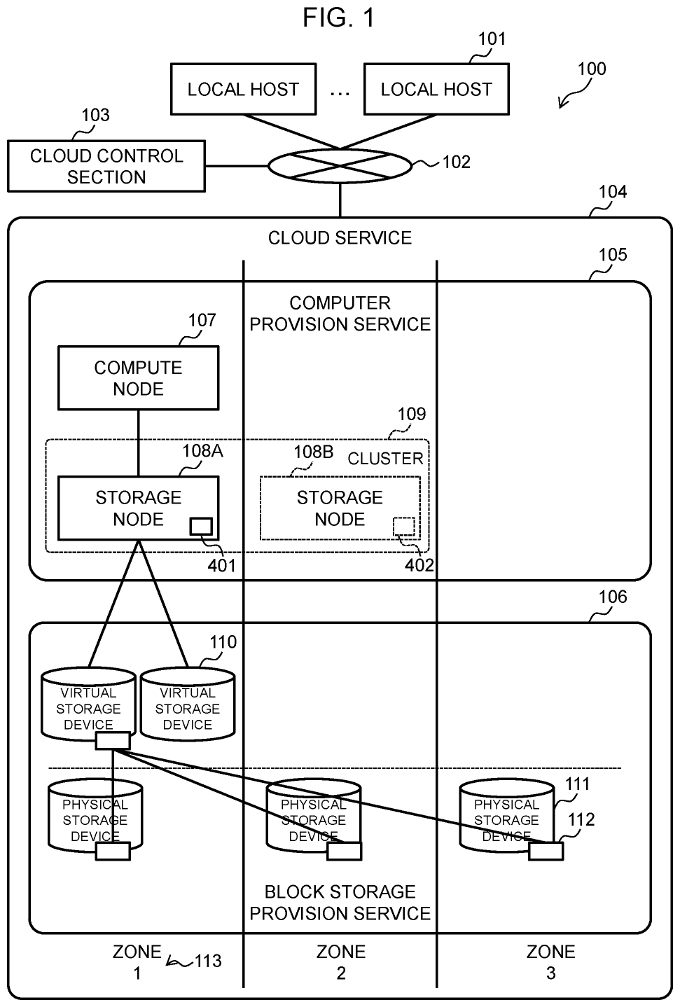

FIG. 1 is a diagram illustrating a configuration of an information processing system 100 according to the first embodiment.

The information processing system 100 depicted in FIG. 1, which is an example of the storage system, includes a plurality of local host devices 101, a cloud control section 103, a cloud service 104, a plurality of compute nodes 107, storage nodes 108A and 108B, a plurality of virtual storage devices 110, and a physical storage device 111. The plurality of local host devices 101 are interconnected through a network 102 including, for example, Ethernet (registered trademark) or a local area network (LAN). The cloud service 104 includes a computer provision service 105 and a block storage provision service 106. The plurality of compute nodes 107 and the storage nodes 108A and 108B are included in the computer provision service 105. The plurality of virtual storage devices 110 and the physical storage device 111 are included in the block storage provision service 106. Further, the storage nodes 108A and 108B form a cluster 109, and include storage control sections 401 and 402, respectively, to let them control the storage nodes 108A and 108B, respectively. It should be noted that, when the storage nodes 108A and 108B are not distinguished from each other, they may simply be referred to as the storage node 108. Further, in this case, it can be said that the storage nodes 108A and 108B are formed by cloud computers, and that the virtual storage devices 110 are cloud storage devices.

The local host devices 101 are general-purpose computer devices that are used by a user of the cloud service 104 in order to use the cloud service 104.

The compute nodes 107 are virtual computer devices provided by a computational provision service that transmits a read request or a write request (hereinafter collectively referred to as appropriate as an I/O request) to the storage nodes 108A and 108B in response to a user operation or a request from an installed application program. It should be noted that the compute nodes 107, which are constructed inside the computer provision service 105 in the present embodiment, may alternatively be constructed outside the cloud service 104, as is the case with the local host devices 101.

The storage node 108 is a physical or virtual server device that provides the compute nodes 107 with a storage area for reading and writing data.

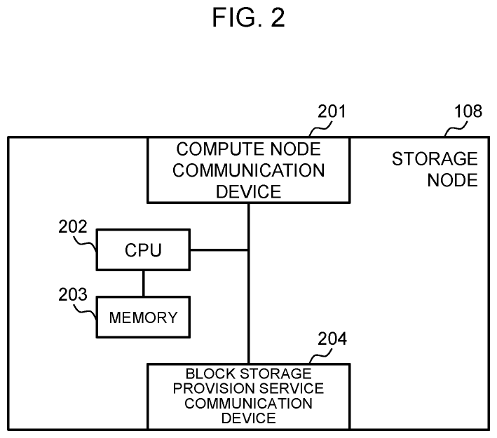

FIG. 2 is a diagram illustrating a hardware configuration of the storage node 108.

As depicted in FIG. 2, the storage nodes 108 each include a compute node communication device 201, a CPU 202, a memory 203, and a block storage provision service communication device 204. These component elements are interconnected through an internal network. The storage nodes 108 each include one or more of each of the component elements. It should be noted that the compute node communication device 201, the CPU 202, the memory 203, and the block storage provision service communication device 204 may each be a virtual device. Further, the compute node communication device 201 and the block storage provision service communication device 204 may be physically different communication devices, may be physically identical but logically separated communication devices, or may be physically and logically identical communication devices.

The compute node communication device 201 is an interface for allowing the storage nodes 108 to communicate with the compute nodes 107, another storage node 108, or the cloud control section 103 through the network, and is formed, for example, by a network interface card (NIC). The compute node communication device 201 provides protocol control when communicating with the compute nodes 107, another storage node 108, or the cloud control section 103.

The CPU 202 is a processor that controls the overall operation of the storage node 108. Further, the memory 203 is formed by a volatile semiconductor memory, such as a static random-access memory (SRAM) or a dynamic RAM (DRAM), and is used to temporarily store various programs and necessary data. When at least one or more CPUs 202 execute a program stored in the memory 203, various processes described below are performed for the whole storage node 108.

Described with reference to FIG. 1 again, the computer provision service 105 is a service that provides a virtual or physical general-purpose computer device to a system administrator.

The block storage provision service 106 is a service that provides a virtual or physical storage device to a computer device provided by the computer provision service 105, such as the storage node 108, through a block storage provision service network. It should be noted that the block storage provision service network may be the same as the network 102, or may be virtually separated by use of a technology such as a virtual LAN (VLAN). In the present embodiment, the block storage provision service 106 provides a virtual storage device to the computer provision service 105, and each area within each virtual storage device is made redundant between the physical storage devices 111 that are present in a plurality of zones 113 (zones 1 to 3 in this case).

The physical storage device 111 includes one or more of different types of large-capacity non-volatile storage devices, such as a serial attached small computer system interface (SCSI) (SAS) solid-state drive (SSD), a non-volatile memory express (NVMe) SSD, a SAS hard disk drive, or a serial advanced technology attachment (SATA) hard disk drive, and provides a physical storage area for reading/writing data in response to a read/write request (hereinafter referred to as an I/O request) from the compute nodes 107.

The cloud service 104 is a service that allows the system administrator to control the computer provision service 105 and the block storage provision service 106 in the information processing system 100. The cloud service 104 allows virtual or physical devices provided by each control target service to be added, deleted, reconfigured, or otherwise changed through the network 102.

### Various Flows of Processing in Information Processing System 100

### Information Stored in Memory of Cloud Control Section 103

A configuration of the cloud service 104 in the information processing system 100 will now be described.

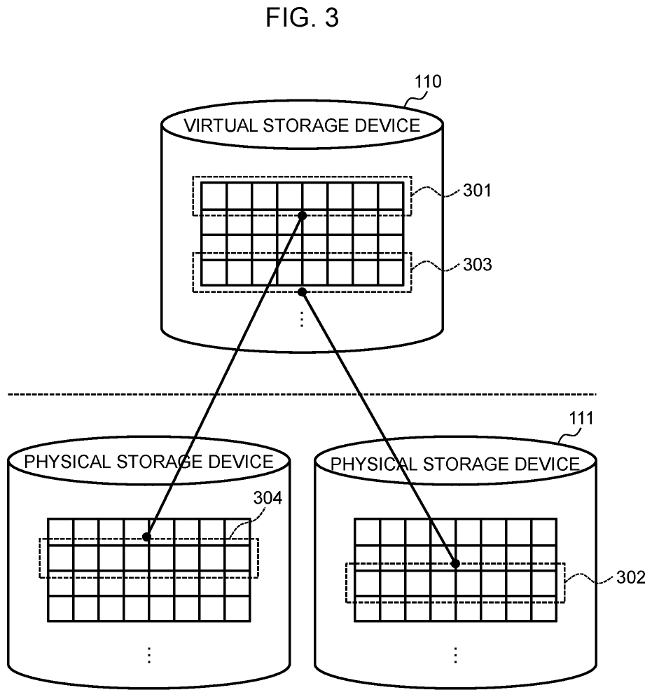

FIG. 3 is a diagram illustrating an example of a configuration of the virtual storage device 110 and the physical storage device 111 and their relation in the first embodiment.

The physical storage device 111 has a physical area that is divided into areas of a certain size, and provides capacity to the virtual storage device 110 in units of the certain size. The units of the certain size in which the capacity is provided to the virtual storage device 110 are hereinafter referred to as chunks. Particularly, the areas in the physical storage device 111 are referred to as physical chunks, and the areas in the virtual storage device 110 are referred to as virtual chunks. FIG. 3 depicts a case where physical chunks 302 are allocated to virtual chunks 303 while physical chunks 304 are allocated to virtual chunks 301. The virtual storage device 110 and the physical storage device 111 do not need to have a 1:1 correspondence. A plurality of physical chunks in one physical storage device 111 may be allocated to a plurality of virtual storage devices 110, or different physical chunks in a plurality of physical storage devices 111 may be allocated to one virtual storage device 110. In this case, the physical chunks can be multiplexed to the virtual chunks. However, it is desirable that the physical storage devices 111 corresponding to the individual physical chunks allocated to one virtual storage device 110 be of the same storage type (e.g., a SAS or an SSD).

The chunks are each formed by sub-blocks that correspond to the minimum unit of I/O processing. The size of a sub-block is 512 bytes when, for example, an SCSI command is used as an I/O command.

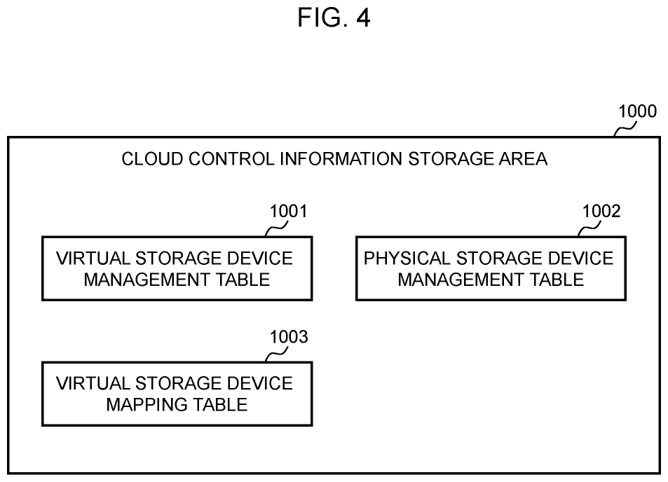

FIG. 4 is a diagram illustrating a memory configuration of the cloud control section 103 in the first embodiment.

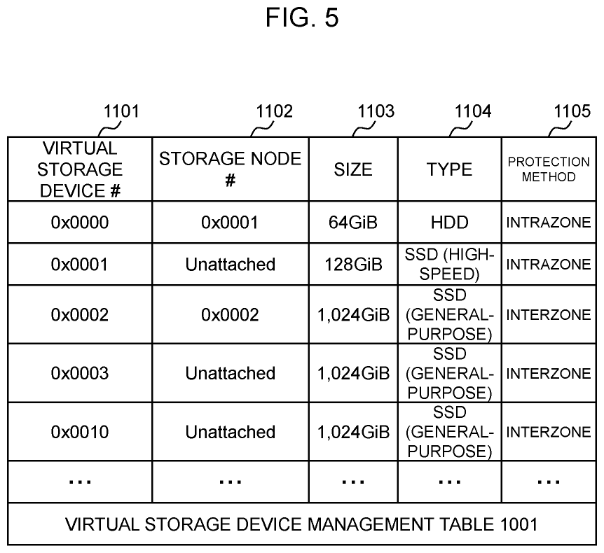

The cloud control section 103 includes a cloud control information storage area 1000. The cloud control information storage area 1000 stores a virtual storage device management table 1001, a physical storage device management table 1002, and a virtual storage device mapping table 1003. These tables will be described in detail with reference to FIGS. 5, 6, and 7, respectively.

FIG. 5 is a diagram illustrating an example of a configuration of the virtual storage device management table 1001 in the first embodiment.

The virtual storage device management table 1001 is a table for managing configuration information regarding the virtual storage devices 110.

A virtual storage device #column 1101 stores the identifiers of the virtual storage devices 110. A storage node #column 1102 stores the identifiers of the storage nodes 108 in a case where the corresponding virtual storage devices 110 are allocated to the storage nodes 108, and stores “Unattached” in a case where the corresponding virtual storage devices 110 are not allocated to the storage nodes 108.

A size column 1103 indicates the capacities of the virtual storage devices 110, and the virtual storage devices 110 are recognized by the storage nodes 108 as storage devices having the capacities indicated in the size column 1103.

A type column 1104 stores information regarding the storage types of the physical storage devices 111 that correspond to the individual physical chunks allocated to the corresponding virtual storage devices 110.

A protection method column 1105 stores information regarding the protection methods for the corresponding virtual storage devices 110. For example, in a case where the protection method is “intrazone,” all of the individual physical chunks corresponding to the virtual chunks in the relevant virtual storage devices 110 are present in the physical storage devices 111 in the same zone 113, and in a case where the protection method is “interzone,” all of the individual physical chunks corresponding to the virtual chunks in the relevant virtual storage devices 110 are present in the physical storage devices 111 in different zones 113.

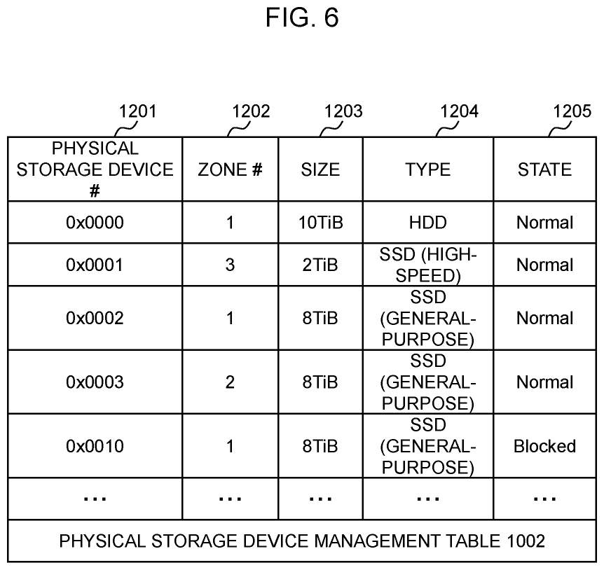

FIG. 6 is a diagram illustrating an example of a configuration of the physical storage device management table 1002 in the first embodiment.

The physical storage device management table 1002 is a table for managing configuration information regarding the physical storage devices 111.

A physical storage device #column 1201 stores the identifiers of the physical storage devices 111.

A zone #column 1202 stores information indicating the zone 113 where the corresponding physical storage devices 111 are present.

A size column 1203 indicates the capacities of the physical storage devices 111. Physical chunks having a capacity larger than that indicated in the size column 1203 cannot be allocated to the virtual storage devices 110.

A type column 1204 stores information regarding the storage types of the physical storage devices 111.

A state column 1205 stores information regarding the states of the corresponding physical storage devices 111. For example, in a case where no failure has occurred in the corresponding physical storage devices 111, the state column 1205 stores information (Normal) indicating such a state. On the other hand, in a case where a failure has occurred in the corresponding physical storage devices 111, the state column 1205 stores information (Blocked) indicating such a failure.

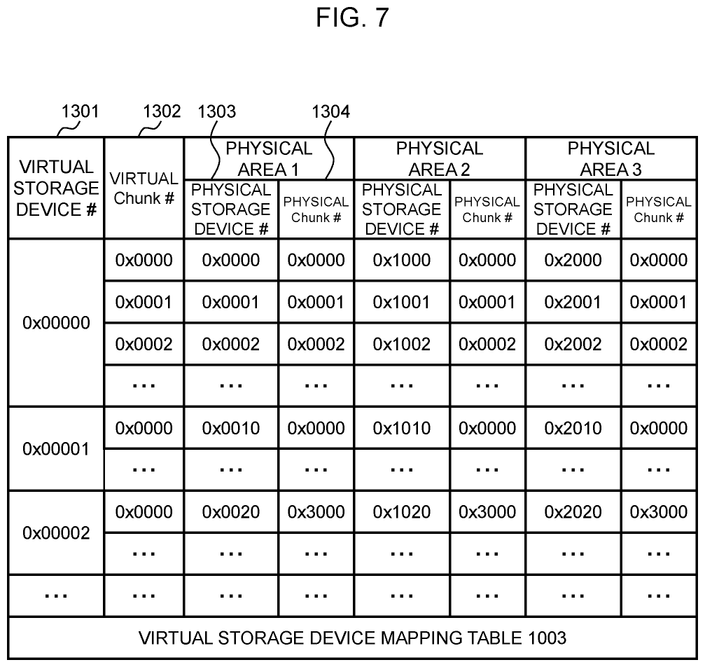

FIG. 7 is a diagram illustrating an example of a configuration of the virtual storage device mapping table 1003 in the first embodiment.

The virtual storage device mapping table 1003 stores information indicating the virtual chunks included the virtual storage devices 110 and mapping information regarding the physical chunks corresponding to the individual virtual chunks.

More specifically, the information stored in the virtual storage device mapping table 1003 indicates the relation between a virtual storage device #1301, which indicates the identifiers of the virtual storage devices 110, and a virtual chunk #1302, which indicates the identifiers of the virtual chunks included in the virtual storage devices 110, and additionally indicates the relation between a physical storage device #1303, which indicates the identifiers of the physical storage devices 111 where a plurality of physical chunks configuring the individual virtual chunks are stored, and a physical chunk #1304, which indicates the locations of the physical chunks in the physical storage devices 111. In the present embodiment, since user data is triplexed, information indicating three physical chunks is stored for each virtual chunk.

### Information Stored in Memory 203 of Storage Node 108

A configuration of each of the storage nodes 108 in the information processing system 100 will now be described.

A control information storage area 2000 and a control program storage area 2100 are present in the memory 203 of each storage node 108.

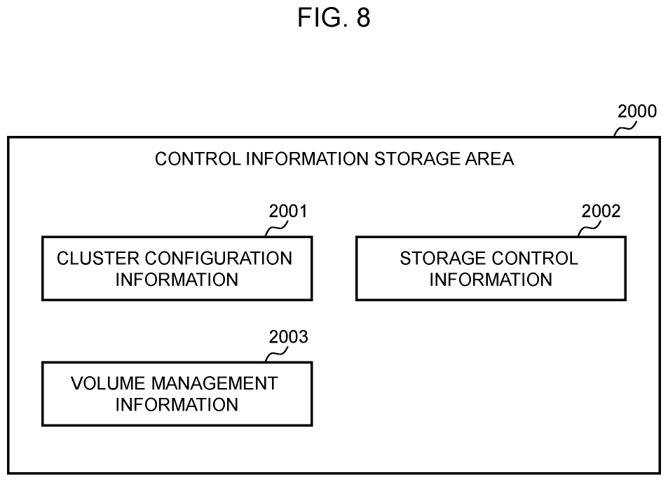

FIG. 8 is a diagram illustrating the control information storage area 2000.

As depicted in FIG. 8, the control information storage area 2000 stores cluster configuration information 2001, storage control information 2002, and volume management information 2003.

The cluster configuration information 2001 manages “active/standby” states of the storage nodes 108A and 108B and storage control sections 401 and 402, which are included in cluster 109, the zone 113 where the “active” and “standby” storage control sections 401 and 402 are present, and the protection methods for the virtual storage devices 110. The protection methods for the virtual storage devices 110 provide the cloud service 104 with data redundancy, such as redundancy within a single zone 113 or redundancy between a plurality of zones 113.

Further, stored as the storage control information 2002 is management information to be used as a storage controller for a software-defined storage (SDS). In the present embodiment, the storage nodes 108A and 108B include the storage control sections 401 and 402, respectively. Each of the storage control sections 401 and 402 is managed as a group for providing redundancy together with one or more other storage control sections implemented for each of other different storage nodes. The above-mentioned group may be configured, for example, as an “active-hot standby” group (an “active-hot standby” state is a substitute for the “active” state and is a state in which the storage control sections are activated but do not accept an I/O request) or as an “active-cold standby” group (an “active-cold standby” state is a substitute for the “active” state and is a state in which the storage control sections are deactivated).

In a configuration adopted by the present embodiment in which one storage control section 401 is set to be “active” and the other storage control section 402 is set to be “hot standby” or “cold standby” as a backup, the storage control section 402 which has been set to be “hot standby” or “cold standby” changes to become “active” if a failure occurs in the storage control section 401 set to be “active,” in the storage node 108A where the storage control section 401 operates, or in zone 1 where the storage node 108A is present. As a result, when the storage control section 401 which is set to be “active” is unable to operate, an I/O process which has been performed by the storage control section 401 can be taken over by the storage control section 402 which had been set to be “hot standby” or “cold standby.” The above-described function is hereinafter referred to as the failover function.

In order to implement the failover function, the storage control sections 401 and 402 belonging to the same group always retain the storage control information 2002 having the same contents. The storage control information 2002 is information necessary for the storage control sections 401 and 402 to perform processes related to various functions, such as a capacity virtualization function, a hierarchical storage control function for moving frequently accessed data to a storage area having a higher response speed, a deduplication function for deleting duplicate data from stored data, a compression function for compressing data and storing the compressed data, a snapshot function for retaining the state of data at a certain point in time, and a remote copy function for copying data synchronously or asynchronously to a remote location for disaster countermeasures. The storage control information 2002 is also retained in the virtual storage devices 110 and made non-volatile. As described later, when a failover process is to be performed, the storage control information 2002 is acquired from the virtual storage devices 110 at a failover destination.

Stored as the volume management information 2003 is management information for providing a volume to the compute nodes 107 by use of the capacity of the virtual storage devices 110.

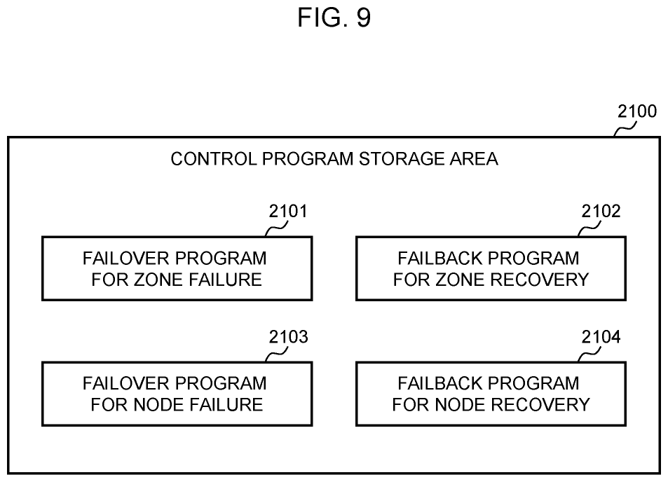

FIG. 9 is a diagram illustrating the control program storage area 2100.

As depicted in FIG. 9, the control program storage area 2100 stores a failover program for zone failure 2101, a failback program for zone recovery 2102, a failover program for node failure 2103, and a failback program for node recovery 2104. These control programs will be described in detail later. It should be noted that the control program storage area 2100 additionally stores programs for controlling various functions such as an I/O processing function and the earlier-mentioned capacity virtualization function. However, the description of such programs is omitted.

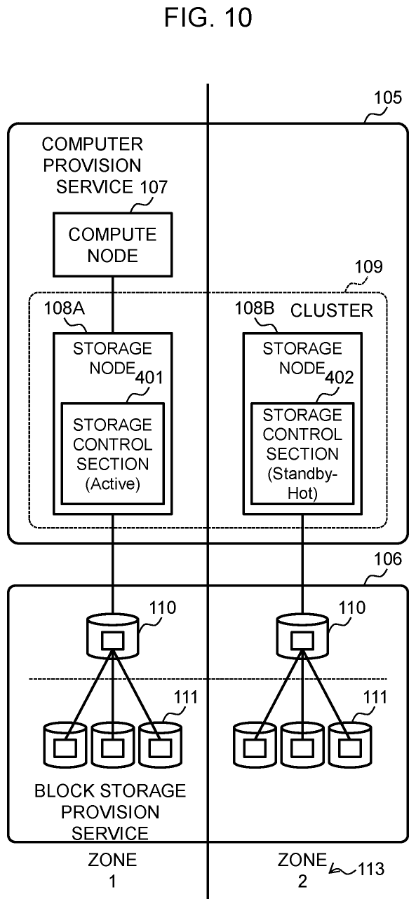

FIG. 10 illustrates an example of a configuration of a storage cluster having zone failure tolerance provided by a conventional technology.

It should be noted that the component elements other than the computer provision service 105 and the block storage provision service 106 within the cloud service 104 are omitted from FIG. 10 because they are common to those in the first embodiment. In the configuration depicted in FIG. 10, the storage nodes 108A and 108B are present in two or more different zones 113, and have the storage control sections 401 and 402, respectively. Further, the storage control sections 401 and 402 are “active” or “hot standby.” The cluster 109 is formed by the storage control section 401 (“active”) which operates on the storage node 108A in zone 1 and by the storage control section 402 (“hot standby”) which operates on the storage node 108B in zone 2. In addition, the virtual storage devices 110 which are to be made redundant within the same zone 113 are attached to corresponding one of the storage nodes 108A and 108B. The virtual storage device 110 attached to the storage node 108A in zone 1 and the virtual storage device 110 attached to the storage node 108B in zone 2 are made redundant (by mirroring) by the storage control sections 401 and 402 to store the same data.

In the configuration depicted in FIG. 10, if, for example, a failure occurs in zone 1, the storage control section 402 (“hot standby”) in zone 2, which receives a failover instruction from a cluster monitoring device (a device that periodically monitors the state of the cluster 109; omitted from FIG. 10), is promoted to be “active,” and takes over an I/O process which has been performed by the storage control section 401 in zone 1.

Since the storage control section 402 in a “hot standby” state is present in zone 2 in the configuration depicted in FIG. 10, it is possible to extremely shorten the period of time between zone failure detection and failover completion. However, the cost of construction becomes an issue because the storage node 108B including the storage control section 402 in the “hot standby” state is always required and, in addition, the virtual storage device 110 needs to be attached also to the storage node 108B.

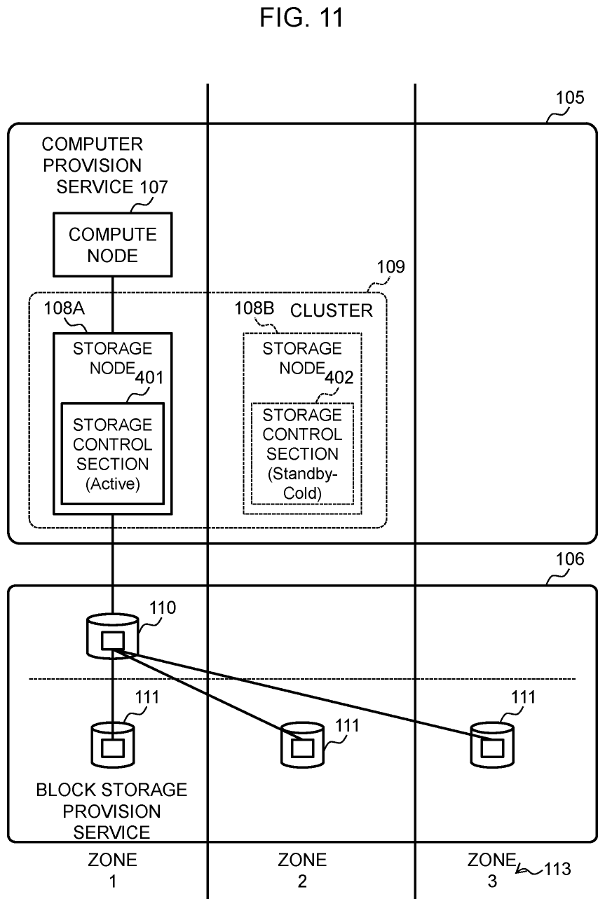

FIG. 11 illustrates an example of the configuration of the storage cluster having zone failure tolerance in the first embodiment.

It should be noted that the following description mainly deals with the differences from the configuration depicted in FIG. 10. In the configuration depicted in FIG. 11, the storage node 108A is present in zone 1, and the storage node 108B in a stopped state is present in zone 2. Although the storage node 108B has the storage control section 402, it has an “active-cold standby” configuration instead of an “active-hot standby” configuration depicted in FIG. 10. The virtual storage device 110 which is to be made redundant between a plurality of zones 113 is attached to the storage node 108A in zone 1.

### Flow of Processing Performed upon Zone Failure Occurrence

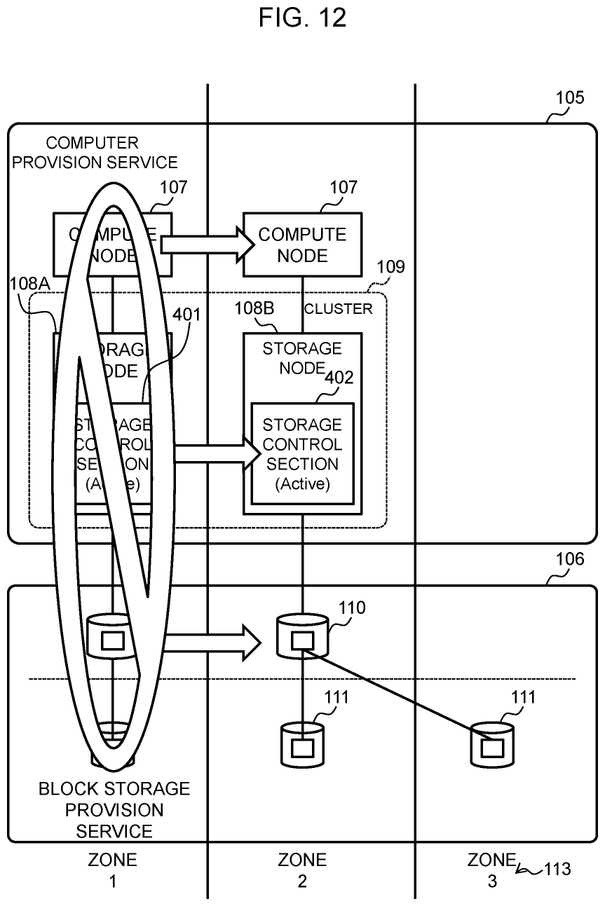

FIG. 12 is a diagram illustrating the overview of a case where, for example, a failure occurs in zone 1 in the configuration depicted in FIG. 11.

First of all, upon receiving a failover instruction from the cluster monitoring device, the storage node 108B starts up in zone 2, and then the storage control section 402 (“cold standby”) is promoted to be “active” and takes over an I/O process which has been performed by the storage control section 401 in zone 1. In addition, the virtual storage device 110 attached to the storage node 108A in zone 1 is detached therefrom and then attached to the storage node 108B in zone 2, which is the failover destination. At this time, the actual data is also present in the physical storage device 111 in zone 2. Therefore, when an I/O request is received from the storage node 108B in zone 2, access between the zones 113 does not occur. This can prevent performance degradation.

In the configuration depicted in FIG. 11, the virtual storage device 110 itself has zone failure tolerance. Therefore, there is no need to separately prepare the virtual storage device 110 in zone 2 and, in addition, it is unnecessary to provide a storage node for writing into the virtual storage device 110. Therefore, the configuration depicted in FIG. 11 is able to achieve significant cost reduction as compared to the configuration depicted in FIG. 10. However, it should be noted that the storage node 108B in zone 2 is not in the “hot standby” state. Consequently, it is well to remember that it takes time to start up the storage node in the event of a zone failure. As a result, the time required for completion of failover becomes slightly longer.

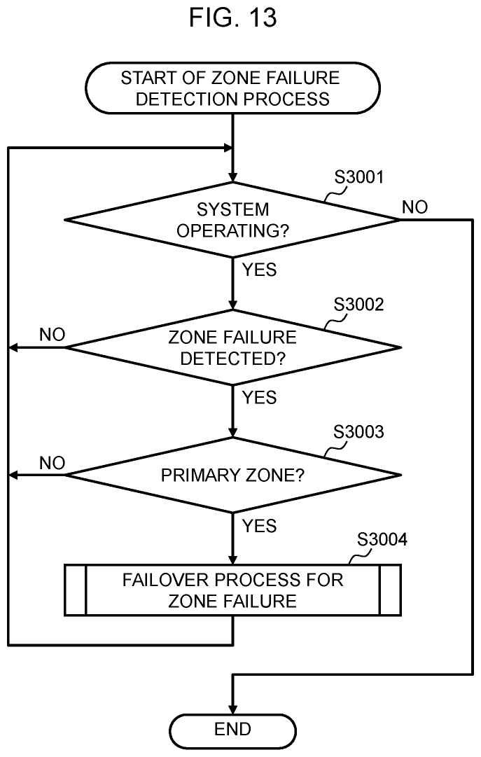

FIG. 13 is a flowchart illustrating a zone failure detection process.

The zone failure detection process is performed by a zone failure detection program to perform a failover process for zone failure upon zone failure detection. More specifically, the zone failure detection process is performed as described below.

First of all, the zone failure detection program determines whether a target system is operating (step S3001).

If the target system is not operating (“NO” in step S3001), the zone failure detection program terminates the zone failure detection process.

On the other hand, if the target system is operating (“YES” in step S3001), the zone failure detection program periodically checks for a zone failure (step S3002).

Then, if a zone failure is detected (“YES” in step S3002), the zone failure detection program calculates primary zone information within storage cluster configuration management information to determine whether the detected zone failure is a failure in a primary zone (step S3003).

If the result of determination indicates that the detected zone failure is a failure in the primary zone (“YES” in step S3003), the zone failure detection program starts the failover process for zone failure (step S3004).

It should be noted that the processing returns to step S3001 in a case where no zone failure is detected (“NO” in step S3002) or the detected zone failure is not a failure in the primary zone (“NO” in step S3003).

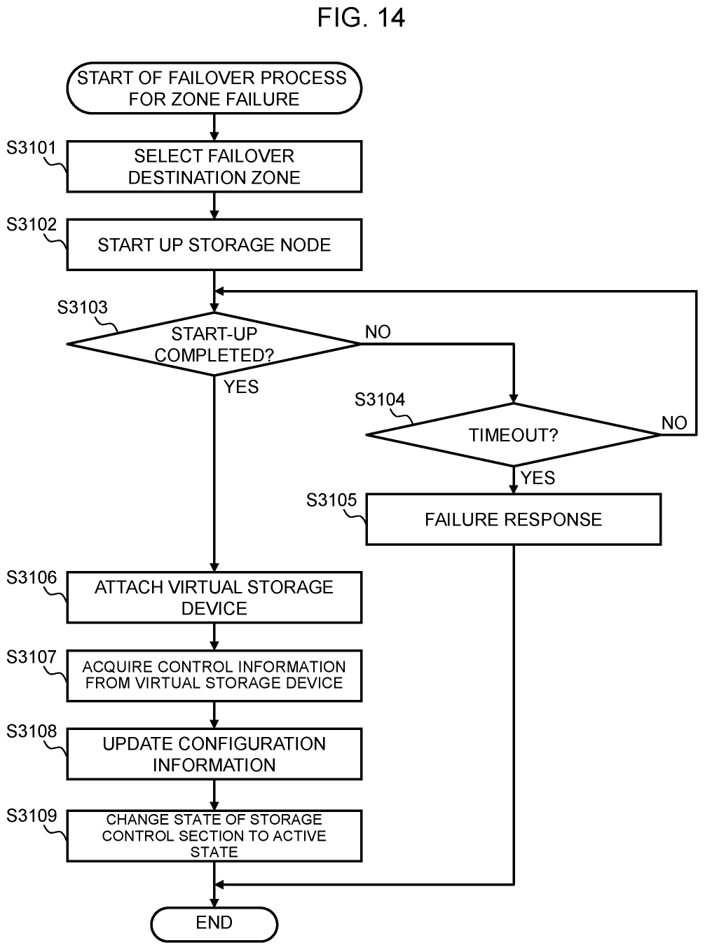

FIG. 14 is a flowchart illustrating the failover process for zone failure in step S3004 of FIG. 13.

The failover process for zone failure is performed by the failover program for zone failure 2101 to perform a storage node failover process. More specifically, the failover process for zone failure is performed as described below.

First of all, the failover program for zone failure 2101 selects a failover destination zone 113 (step S3101). It is desirable that the failover destination zone 113 be selected from the zones 113 where the physical storage device 111 corresponding to the virtual storage device 110 attached to the storage node 108A at a failover source is present. The following description assumes that zone 2 is selected as the failover destination.

The failover program for zone failure 2101 starts up the storage node 108B (step S3102). The storage node 108B is in the stopped state. Therefore, it is probable that the start-up of the storage node 108B will take time or will not be completed within a predetermined period of time due, for instance, to the insufficiency of resources of the cloud service 104. Consequently, the failover program for zone failure 2101 periodically checks whether the start-up is completed (step S3103).

Then, if the start-up is not completed (“NO” in step S3103) or if a predetermined period of time has elapsed (timeout) (“YES” in step S3104), the failover program for zone failure 2101 notifies the system administrator that the failover has failed (step S3105). It should be noted that the processing returns to step S3103 if the predetermined period of time has not elapsed (“NO” in step S3104).

On the other hand, if the failover program for zone failure 2101 confirms that the start-up is completed (“YES” in step S3103), the failover program for zone failure 2101 attaches the virtual storage device 110 which has been attached to the storage node 108A at the failover source to the storage node 108B at the failover destination that is already started up (step S3106).

Subsequently, the storage control section 402 of the storage node 108B at the failover destination acquires control information regarding the cluster 109 from the virtual storage device 110 (step S3107), and updates the storage cluster configuration management information in the storage node 108B (step S3108). Finally, the failover program for zone failure 2101 changes the state of the storage control section 402 from a “cold standby” state to an “active” state, and completes the failover process for zone failure (step S3109).

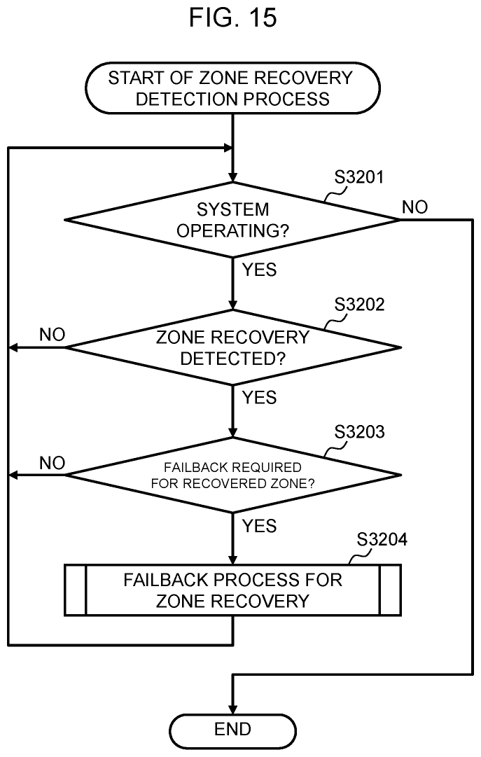

FIG. 15 is a flowchart illustrating a zone recovery detection process.

The zone recovery detection process is performed by a zone recovery detection program to perform a failback process for zone recovery upon zone recovery detection. More specifically, the zone recovery detection process is performed as described below.

First of all, the zone recovery detection program determines whether the target system is operating (step S3201).

If the result of determination indicates that the target system is not operating (“NO” in step S3201), the zone recovery detection program terminates the zone recovery detection process.

On the other hand, if the target system is operating (“YES” in step S3201), the zone recovery detection program periodically checks for zone recovery (step S3202).

Then, if the zone recovery detection program detects zone recovery (“YES” in step 3202), the zone recovery detection program determines whether or not failback is required for a recovered zone 113 (step S3203). More specifically, the zone recovery detection program may notify the system administrator of zone recovery detection and allow the system administrator to determine whether or not the failback is needed. An alternative is to perform setup to allow the zone recovery detection program to automatically achieve failback upon target zone recovery.

If the zone recovery detection program determines that the failback is needed (“YES” in step S3203), the zone recovery detection program starts the failback process for zone recovery (step S3204).

If the zone recovery detection program does not detect zone recovery (“NO” in step 3202) or determines that the failback is not needed (“NO” in step S3203), the processing returns to step S3201.

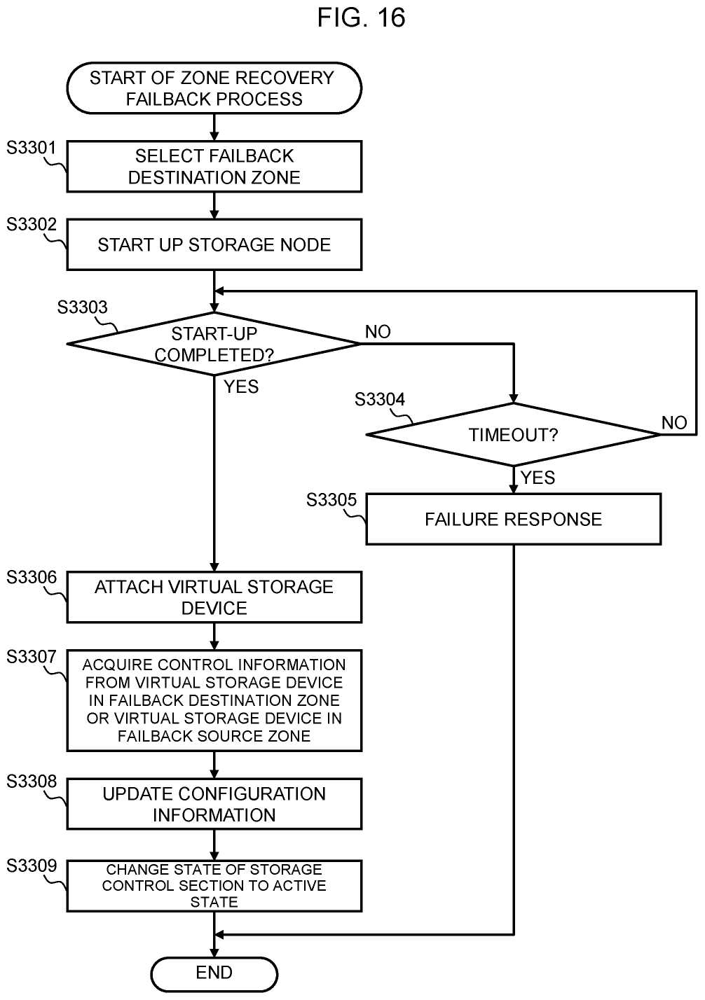

FIG. 16 is a flowchart illustrating the failback process for zone recovery in step S3204 of FIG. 15.

The failback process for zone recovery is performed by the failback program for zone recovery 2102 to perform a storage node failback process. More specifically, the failback process for zone recovery is performed as described below.

First of all, the failback program for zone recovery 2102 selects a failback destination zone 113 (step S3301). The failback destination zone 113 may be determined by the system administrator or may be predetermined in advance. The following description assumes that zone 1 is selected as the failback destination.

The failback program for zone recovery 2102 starts up the storage node 108A (step S3302). The storage node 108A is in the stopped state. Therefore, it is probable that the start-up of the storage node 108A will take time or will not be completed within a predetermined period of time due, for instance, to the insufficiency of resources of the cloud service 104. Consequently, the failback program for zone recovery 2102 periodically checks whether the start-up is completed (step S3303).

If the start-up is not completed (“NO” in step S3303) and a predetermined period of time has elapsed (timeout) (“YES” in step S3304), the failback program for zone recovery 2102 notifies the system administrator that the failback has failed (step S3305). It should be noted that the processing returns to step S3303 if the predetermined period of time has not elapsed (“NO” in step S3304).

On the other hand, if the failback program for zone recovery 2102 confirms that the start-up is completed (“YES” in step S3303), the failback program for zone recovery 2102 attaches the virtual storage device 110 which has been attached to the storage node 108B at a failback source to the storage node 108A at the failback destination that is already started up (step S3306).

Subsequently, the storage control section 401 of the storage node 108A at the failback destination acquires control information regarding the cluster 109 from the virtual storage device 110 or the storage node 108B at the failback source (step S3307), and updates the storage cluster configuration management information in the storage node 108B (step S3308).

Finally, the failback program for zone recovery 2102 changes the state of the storage control section 401 to the “active” state, stops the storage node 108B at the failback source, and completes the failback process for zone recovery (step S3309).

It can be said that the information processing system 100 described above is a storage system configured as described below. The information processing system 100 runs on a plurality of cloud computers disposed in a plurality of different zones (zones 1 to 3 in the above-described example) and provided with storage nodes disposed in the plurality of computers in the plurality of zones to process inputted/outputted data. The storage nodes include a first storage node (the storage node 108A in the above-described example) that operates during normal operation and a second storage node (the storage node 108B in the above-described example) that is present in a zone (zone 2 in the above-described example) different from that where the first storage node is present and that is able to take over processing of the first storage node. The plurality of cloud computers have a storage device (the physical storage device 111 in the above-described example) and a virtual storage device 110. The storage device physically stores data that is to be processed by the storage nodes. The virtual storage device 110 stores data that is made redundant between the zones by a plurality of the storage devices disposed in the different zones. The storage system accesses data in the virtual storage device 110 by using the storage control information 2002, and stores the storage system in the virtual storage device 110. The virtual storage device 110 makes the stored data redundant between the zones. If a failure occurs in a zone including the first storage node, the second storage node takes over the processing of the first storage node by using the data made redundant between the zones.

If, in the above instance, a failure occurs in a zone (zone 1 in the above-described example) including the first storage node (the storage node 108A in the above-described example), the virtual storage device 110 attached to the second storage node in the same zone (zone 2 in the above-described example) as that where the second storage node (the storage node 108B in the above-described example) is present achieves virtual memory by using a storage device (the physical storage device 111 in the above-described example) that is present in the same zone as that where the second storage node is present.

Further, it can be said that the information processing system 100 described above is a storage system configured as described below. The information processing system 100 includes a first storage node, a second storage node, and a virtual storage device 110. The first storage node (the storage node 108A in the above-described example) operates during normal operation. The second storage node (the storage node 108B in the above-described example) is present in a zone (zone 2 in the above-described example) different from that where the first storage node is present, and remains in the stopped state during normal operation of the first storage node. The virtual storage device 110 is connected to the first storage node during normal operation of the first storage node. If a failure occurs in a zone (zone 1 in the above-described example) including the first storage node, the storage system starts up the second storage node, connects the virtual storage device 110 to the second storage node, and causes the second storage node to operate as a substitute for the first storage node.

Further, it can be said that, during normal operation of the first storage node, the virtual storage device 110 is not connected to a storage node other than the first storage node, and that, if a failure occurs in a zone (zone 1 in the above-described example) including the first storage node, the virtual storage device 110 connected to the first storage node in the same zone as that where the first storage node is present is detached therefrom and then attached to the second storage node in the same zone (zone 2 in the above-described example) as that where the second storage node is present.

Moreover, it can be said that, if a failure occurs in a zone including the first storage node in a situation where the virtual storage device 110 achieves virtual memory and is connected to the physical storage devices 111 which are present in a plurality of zones to provide redundancy, the virtual storage device 110 attached to the second storage node in the same zone as that where the second storage node is present achieves virtual memory by using the physical storage devices 111 that are present in the same zone as that where the second storage node is present.

### Flow of Processing Performed upon Node Failure Occurrence

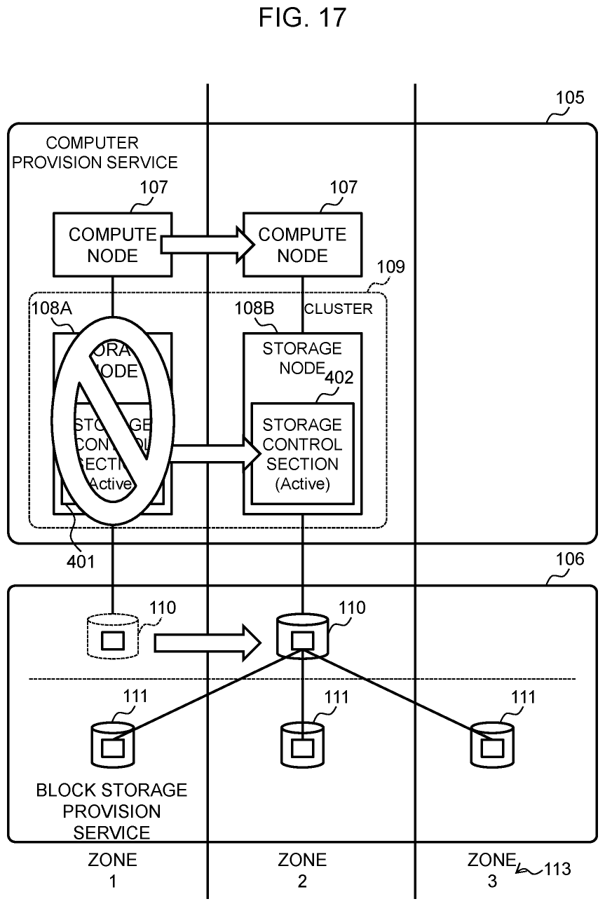

FIG. 17 is a diagram illustrating the overview of a case where, for example, a failure occurs in the storage node 108A in zone 1 in the configuration depicted in FIG. 11.

More specifically, while FIG. 11 depicts a case where a failure occurs in the whole of zone 1, FIG. 17 depicts a case where a failure occurs only in the storage node 108A within zone 1.

The failover process performed in the event of a failure is similar to that in the case described with reference to FIG. 14 except that the failover program for node failure 2103 is used instead of the failover program for zone failure 2101. More specifically, first of all, the failover program for node failure 2103 starts up the storage node 108B. Then, the failover program for node failure 2103 attaches the virtual storage device 110 to the storage node 108B at the failover destination that is already started up. Further, the failover program for node failure 2103 changes the state of the storage control section 402 from the “cold standby” state to the “active” state.

In addition, the failback process performed to achieve recovery is similar to that in the case described with reference to FIG. 16 except that the failback program for node recovery 2104 is used instead of the failback program for zone recovery 2102. More specifically, first of all, the failback program for node recovery 2104 starts up the storage node 108A. Then, the failback program for node recovery 2104 attaches the virtual storage device 110 to the storage node 108A at the failback destination that is already started up. Further, the failback program for node recovery 2104 changes the state of the storage control section 401 to the “active” state, and stops the storage node 108B at the failback source.

It can be said that, if a failure occurs only in the first storage node (the storage node 108A in the above-described example) while the configuration depicted in FIG. 17 is adopted, the virtual storage device 110 attached to the second storage node in the same zone (zone 2 in the above-described example) as that where the second storage node (the storage node 108B in the above-described example) is present achieves virtual memory by using not only the physical storage device 111 that is present in the same zone as that where the second storage node is present but also the physical storage device 111 that is present in the same zone as that where the first storage node is present.

### Second Embodiment

A second embodiment of the present invention will now be described. If a failure occurs in the storage node 108A in the first embodiment, the failover destination is in a different zone. Therefore, inter-zone communication occurs during I/O processing, resulting in performance degradation. Consequently, the second embodiment is configured to provide redundancy in the zones 113 to avoid performance degradation in the event of a storage node failure while maintaining zone failure tolerance.

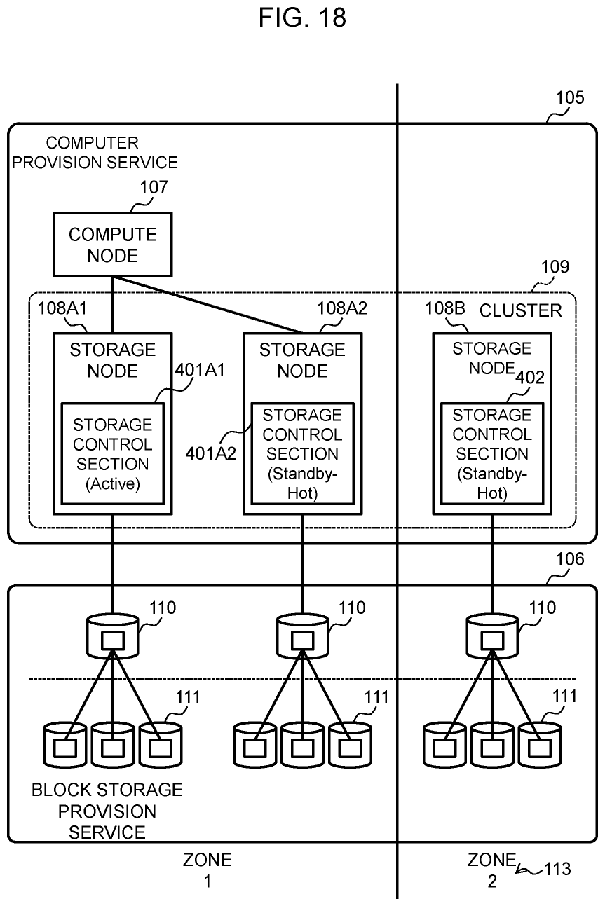

FIG. 18 is a diagram illustrating a conventional method for providing redundancy even in the zones 113.

In the case depicted in FIG. 18, storage nodes 108A1 and 108A2 are present in zone 1 and have storage control sections 401A1 and 401A2, respectively. Further, the storage node 108B is present in zone 2 and has the storage control section 402. Moreover, the storage control sections 401A1, 401A2, and 402 are “active” or “hot standby.” The cluster 109 is formed by the storage control section 401A1 (“active”) operating in the storage node 108A1 in zone 1, the storage control section 401A2 (“hot standby”) operating in the storage node 108A2 in zone 1, and the storage control section 402 (“hot standby”) operating in the storage node 108B in zone 2. In addition, the virtual storage devices 110 which are made redundant within the same zone 113 are attached to corresponding one of the storage nodes 108A1, 108A2, 108B. The virtual storage device 110 attached to the storage node 108A1 in zone 1, the virtual storage device 110 attached to the storage node 108A2 in zone 1, and the virtual storage device 110 attached to the storage node 108B in zone 2 store the same data because they are made redundant (by mirroring) by the storage control sections 401A1, 401A2, and 402.

If, for example, a failure occurs in the storage node 108A1 in zone 1 in the configuration depicted in FIG. 18, the storage control section 401A2 (“hot standby”) in zone 1 is promoted to be “active” upon receiving a failover instruction from the cluster monitoring device (the device that periodically monitors the state of the cluster 109; omitted from FIG. 18), and takes over an I/O process which has been performed by the storage control section 401A1 in zone 1.

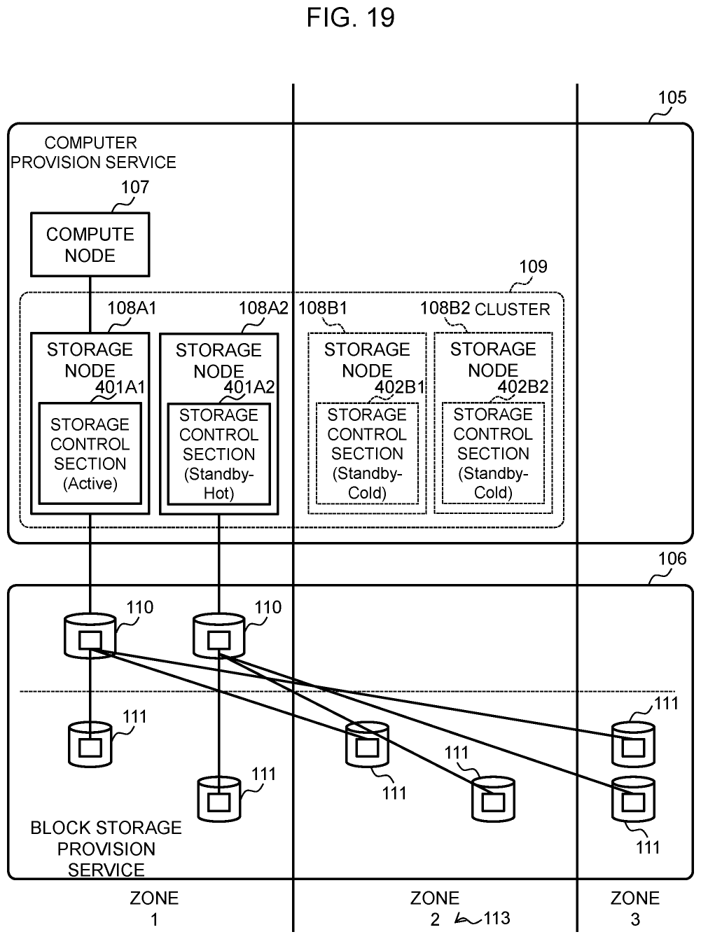

FIG. 19 is a diagram illustrating a configuration of the information processing system 100 according to the second embodiment.

The storage nodes 108A1 and 108A2 are present in zone 1, and storage nodes 108B1 and 108B2 in the stopped state are present in zone 2. The storage nodes 108A1 and 108A2 respectively have the storage control sections 401A1 and 401A2, which are “active” and “hot standby,” respectively. Further, the storage nodes 108B1 and 108B2 respectively have storage control sections 402B1 and 402B2, both of which are “cold standby.” The virtual storage devices 110 which are made redundant between a plurality of zones 113 are attached to the storage nodes 108A1 and 108A2 in zone 1.

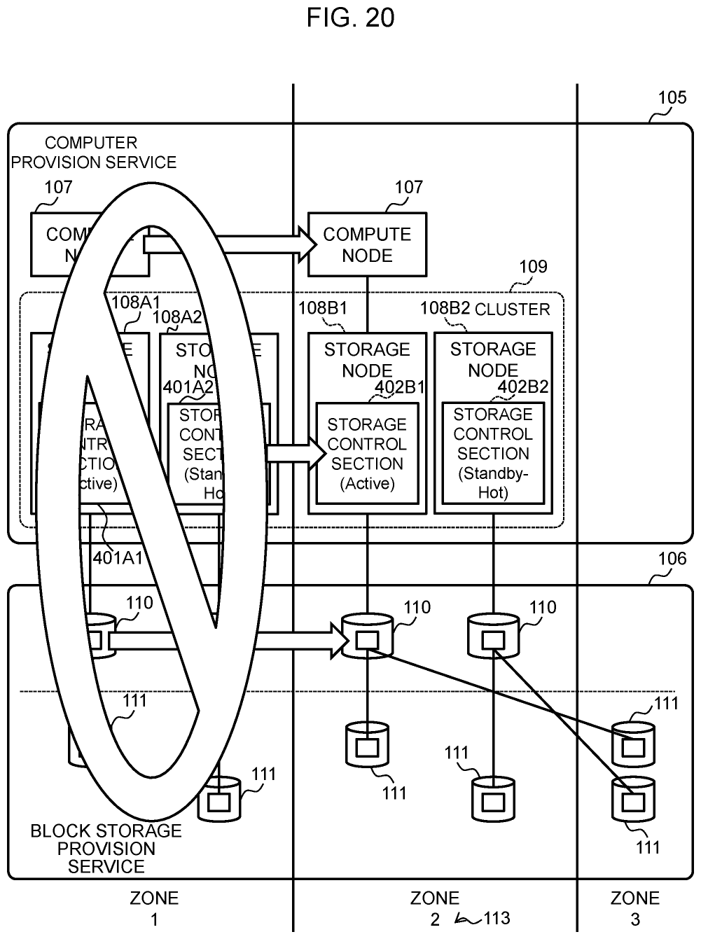

FIG. 20 is a diagram illustrating the overview of a case where a failure occurs in zone 1 in the configuration depicted in FIG. 19.

First of all, upon receiving a failover instruction from the cluster monitoring device, the storage nodes 108B1 and 108B2 start up in zone 2, and the storage control section 402B1 (“cold standby”) is then promoted to be “active” and takes over an I/O process which has been performed by a storage control section 402A1 in zone 1.Further, the storage control section 402B2 (“cold standby”) becomes “hot standby.” In addition, the virtual storage devices 110 attached to the storage nodes 108A1 and 108A2 in zone 1 are detached therefrom and then attached to the storage nodes 108B1 and 108B2 in zone 2, which is the failover destination.

If a failure occurs in zone 1 in the configuration depicted in FIGS. 19 and 20, the two “cold standby” storage control sections in zone 2 become “active” and “hot standby,” respectively. This makes it possible to maintain a redundant configuration in the zones 113.

It can be said that, in the information processing system 100 according to the second embodiment, when a third storage node (the storage node 108A2 in the above-described example) and a second virtual storage device 110 connected to the third storage node are present in the same zone (zone 1 in the above-described example) as that where the first storage node (the storage node 108A1 in the above-described example) is present, the first storage node and the virtual storage device 110 are made redundant within the same zone.

Further, if a failure occurs only in the storage node 108A1 in zone 1, the storage control section 401A2 (“hot standby”) in zone 1 is promoted to be “active” upon receiving a failover instruction from the cluster monitoring device, and takes over an I/O process which has been performed by the storage control section 401A1 in zone 1.

In the above case, it can be said that, if a failure occurs only in the first storage node (the storage node 108A1 in the above-described example), the information processing system 100 according to the second embodiment operates the third storage node (the storage node 108A2 in the above-described example) and the second virtual storage device 110 that are present in the same zone (zone 1 in the above-described example) as that where the first storage node is present.

### Description of Control Method of Information Processing System 100

The processing performed by the information processing system 100 described above is implemented by allowing software and hardware resources to collaborate with each other. More specifically, each of the above-described functions is implemented by allowing a processor in the computer provided in the information processing system 100 to load software implementing each of the above-described functions into a memory and execute the loaded software.

Consequently, the processing performed by the information processing system 100 can be understood as a control method for a storage system as follows. The storage system is implemented by allowing the processor to execute the software recorded in a memory and is configured to run on a plurality of cloud computers disposed in a plurality of different zones. The storage system includes storage nodes that are disposed in the plurality of computers in the plurality of zones to process inputted/outputted data. The storage nodes include a first storage node and a second storage node. The first storage node operates during normal operation. The second storage node is present in a zone different from that where the first storage node is present, and is able to take over processing of the first storage node. The plurality of cloud computers have a storage device and a virtual storage device. The storage device physically stores data that is to be processed by the storage nodes. The virtual storage device stores data that is made redundant between the zones by a plurality of the storage devices disposed in the different zones.

The storage system accesses data in the virtual storage device by using storage control information, and stores the storage system in the virtual storage device. The virtual storage device makes the stored data redundant between the zones. If a failure occurs in a zone including the first storage node, the second storage node takes over the processing of the first storage node by using the data made redundant between the zones.

Although the embodiments have been described above, the technical scope of the present invention is not limited to the scope described in conjunction with the above-described embodiments. It is obvious from the definition of the appended claims that various changes or improvements made to the above embodiments are also included within the technical scope of the present invention.

What is claimed is:

1. A storage system that runs on a plurality of cloud computers disposed in a plurality of different zones, the storage system comprising:
storage nodes that are disposed in the plurality of computers in the plurality of zones to process inputted/outputted data,
wherein the storage nodes include a first storage node and a second storage node, the first storage node operating during normal operation, the second storage node being present in a zone different from that where the first storage node is present and being able to take over processing of the first storage node,
the plurality of cloud computers have a storage device and a virtual storage device, the storage device physically storing data that is to be processed by the storage nodes, the virtual storage device storing the data that is made redundant between the zones by a plurality of the storage devices disposed in the different zones,
the storage system accesses data in the virtual storage device by using storage control information, and stores the storage system in the virtual storage device,
the virtual storage device makes the stored data redundant between the zones, and,
if a failure occurs in a zone including the first storage node, the second storage node takes over the processing of the first storage node by using the data made redundant between the zones.

2. The storage system according to claim 1,
wherein the virtual storage device makes the stored data and the storage control information redundant between the zones, and,
if a failure occurs in a zone including the first storage node, the second storage node takes over the processing of the first storage node by using the data and the storage control information that are made redundant between the zones.

3. The storage system according to claim 1,
wherein, during normal operation of the first storage node, the virtual storage device is not connected to a storage node other than the first storage node, and,
if a failure occurs in a zone including the first storage node, the virtual storage device connected to the first storage node in the same zone as that where the first storage node is present is detached therefrom and then attached to the second storage node in the same zone as that where the second storage node is present.

4. The storage system according to claim 3,
wherein, if a failure occurs in a zone including the first storage node, the virtual storage device attached to the second storage node in the same zone as that where the second storage node is present achieves virtual memory by using the storage device that is present in the same zone as that where the second storage node is present.

5. The storage system according to claim 4,
wherein, if a failure occurs only in the first storage node, the virtual storage device attached to the second storage node in the same zone as that where the second storage node is present achieves virtual memory by using the storage device that is present in the same zone as that where the first storage node is present, in addition to the storage device that is present in the same zone as that where the second storage node is present.

6. The storage system according to claim 1,
wherein, when a third storage node and a second virtual storage device connected to the third storage node are present in the same zone as that where the first storage node is present, the first storage node and the virtual storage device are made redundant within the same zone.

7. The storage system according to claim 6,
wherein, if a failure occurs only in the first storage node, the storage system operates the third storage node and the second virtual storage device that are present in the same zone as that where the first storage node is present.

8. The storage system according to claim 1,
wherein the virtual storage device is used as a cloud storage device.

9. A control method for a storage system that is implemented by allowing a processor to execute software recorded in a memory and is configured to run on a plurality of cloud computers disposed in a plurality of different zones,
wherein the storage system includes storage nodes that are disposed in the plurality of computers in the plurality of zones to process inputted/outputted data,
the storage nodes include a first storage node and a second storage node, the first storage node operating during normal operation, the second storage node being present in a zone different from that where the first storage node is present and being able to take over processing of the first storage node,
the plurality of cloud computers have a storage device and a virtual storage device, the storage device physically storing data that is to be processed by the storage nodes, the virtual storage device storing the data that is made redundant between the zones by a plurality of the storage devices disposed in the different zones,
the storage system accesses data in the virtual storage device by using storage control information, and stores the storage system in the virtual storage device,
the virtual storage device makes the stored data redundant between the zones, and,
if a failure occurs in a zone including the first storage node, the second storage node takes over the processing of the first storage node by using the data made redundant between the zones.
